(19) United States
(12) Patent Application Publication
(10) Pub. No.: US 2004/0036251 A1
(43) Pub. Date: Feb. 26, 2004

(54) Cycle wheel mounting, components thereof and cycle including wheel mounting

(76) Inventor: Kenneth William Baldwin, Norwich (GB)

Correspondence Address: KENNETH WILLIAM BALDWIN, 529 TALBOT ROAD, STEVENSVILLE, MD, 21666, US

(21) Appl. No.: 10/646,591

(22) Filed: Aug. 22, 2003

Related U.S. Application Data
(60) Provisional application No. 60/405,118, filed on Aug. 23, 2002.

(51) Int. Cl. B62K 25/02

(52) U.S. Cl. 280/284

(57) ABSTRACT

A mounting for a cycle wheel between the legs of a fork of a cycle frame in which the wheel has rolling bearings at opposite ends of a hub. The outer raceways of the bearings are de-mountably securable to the two legs of the fork, and the inner raceways are removably secured to the hub so as normally to remain attached to the hub if the wheel is de-mounted from the fork. Typically the hub has first and second wheel supports projecting axially outward therefrom, and each support has means for attaching thereto an inner raceway. The distal ends of the fork legs each comprises releasable retaining means for retaining an outer raceway. The wheel and rolling bearings can thereby be removed as a single unit from the fork when required. The releasable mounting includes a quick release catch and may be an annular clamp. Each rolling bearing is located in line with the fork leg to which it is attached, thereby reducing mechanical stress on the rolling bearing, and preferably is a sealed bearing.

By mounting the wheel hub to the inner raceways and releasably attaching the outer raceways to the legs of a fork, there is no requirement for any axle or other elongate member to support the inner raceways of the bearings and/or secure the wheel hub to the fork.

### FIELD OF THE INVENTION

The invention relates to a mounting for a cycle wheel, components of such a wheel mounting and cycles including the wheel mounting.

### BACKGROUND OF THE INVENTION

The principle of cycle hub design has remained virtually unchanged for over 100 years. An axle passing through the cycle hub is clamped to the distal ends of first and second legs of a cycle fork, locked in position with lock-nuts. An external portion of the hub with end flanges for retaining spokes at either end is fitted around the axle, and rotates around the axle by virtue of rolling-bearings formed at either end of the axle. The rolling bearings comprise an inner raceway formed in a hardened steel cone screwed to either end of the axle, and an outer raceway is formed by a hardened steel cup at either end of the hub. In use, the axle remains fixed to the forks, with the external portion of the hub, the end flanges, spokes and the wheel attached thereto rotating relative to the forks. Many modern hubs have hollow axles to enable a quick release skewer mechanism.

A limitation of conventional cycle hubs is that they can be difficult to service. Replacing the rolling bearings is not an easy task, due in part to the number of separate components in a traditional hub.

The reliance of a traditional hub on the axles to give it mechanical strength is also a limitation, as such axles can be bent or broken in use.

U.S. Pat. No. 4,632,415 (San Hai) discloses fork ends and a hub for a bicycle including a pair of annular bearings each located within an annular bearing shell fixed permanently to the fork ends, and including an outer race and an inner race which is formed by engaging two separate rings. In use, a hub formed with several longitudinal grooves is located between the fork ends, and a spindle formed with several lengthwise extensions corresponding to the grooves on the hub is passed through the annular bearing shells and the hub, and fixed on one side with a nut. This device has relatively few components, however it is still difficult to replace the bearings. The location of the annular bearing in line with the forks reduces the mechanical load on the hub, in particular, the annular bearings.

U.S. Pat. No. 5,549,315 (Ashman) discloses apparatus for mounting a cycle wheel where roller bearings are mounted in line with the fork legs. The wheel is attached by passing a spindle through the roller bearings and bicycle hub. The spindle rotates with the wheel, rather than being fixed to the distal ends of the fork legs like the axle of a conventional cycle.

It is an object of the present invention to provide an improved cycle wheel mounting.

### SUMMARY OF THE INVENTION

According to a first aspect of the present invention there is provided a cycle wheel mounting comprising a cycle fork and cycle wheel, the fork having first and second legs with distal ends for holding the cycle wheel therebetween, the cycle wheel including a hub having first and second wheel supports projecting axially outward from the ends thereof, each wheel support having means for attaching thereto an inner raceway which together with an outer raceway forms a rolling bearing, the distal ends of the fork legs each comprising releasable retaining means for retaining an outer raceway of a bearing, such that the wheel and rolling bearings can be secured to the fork, and can be removed as a single unit therefrom when required.

According to a second aspect of the present invention, there is provided a mounting for a cycle wheel between the legs of a fork of a cycle frame in which the wheel has a rolling bearing at opposite ends of a hub, the outer raceways of which are de-mountably securable to the two legs of the fork, and in which the inner raceways are removably secured to the hub and will normally remain attached to the hub if the wheel is de-mounted from the cycle frame.

Thus a wheel can be readily demounted by releasing the retaining means for retaining the outer bearing raceways, allowing the wheel and bearings to be detatched from the fork. The wheel can be re-attached by re-engaging the bearings within the retaining means.

Preferably, the releasable retaining means comprise an openable annular clamp including a quick release catch, configured to retain the outer raceways. This allows the wheel to be rapidly mounted and de-mounted by a user.

Preferably, the retaining means for retaining the outer raceways operate independently, such that each may be engaged and disengaged separately.

Preferably, each rolling bearing is a unitary component so that the components of the rolling bearing ordinarily remain attached to the cycle wheel so that it can be conveniently carried without coming apart.

A hub constructed in accordance with the present invention can be formed as a single unitary structure. Typically, the hub has a flange at each end, with the first and second wheel supports projecting outwardly from the flanges. The flanges may be part of the same unitary structure as the rest of the hub, and where the wheel includes spokes these may extend from the flanges to the rim of the wheel.

Preferably each rolling bearing is located in line with the fork leg to which it is attached. Thus, the external load on the rolling bearings is perpendicular to the central axis of the rolling bearing, thereby reducing mechanical stress on the rolling bearing.

Preferably, the means for attaching an inner raceway allows the latter to be de-mounted from its wheel supports.

For example, the means for attaching an inner raceway may comprise an internally threaded recess within the wheel support, for receiving a threaded screw passing through the inner raceway and tightened so that in use it holds the raceway against the wheel support.

Alternatively, the inner raceway of each rolling bearing may include a screw-threaded stub axially protruding from one end thereof and is retainable in use by being screwed into an internally threaded recess in the wheel support so that the bearing is mounted so as to extend axially therefrom.

Thus, the rolling bearings will normally remain attached to the cycle wheel hub even when the wheel is demounted from the fork, but after a wheel is so demounted they can be removed from the hub if required, e.g. for purpose of replacement.

Preferably, the means for attaching the two inner raceways of the two bearings attached to a hub are independent of each other, allowing each rolling bearing to be independently demounted for example for replacement.

Each rolling bearing may be a sealed bearing such as a dust-cover sealed bearing. Dust-cover sealed bearings developed for use in hay rakes or other waterproof, debris-sealed or dust-sealed bearings developed for use in mining, agricultural and other industrial applications are also suitable.

In an alternative embodiment, the inner raceway could be an integral part of the hub.

According to a third aspect of the present invention there is provided a cycle wheel including a hub having bearings demountably attached thereto, as herein disclosed.

According to a fourth aspect of the present invention there is provided a cycle fork forming part of a cycle frame or adapted to be attached to a cycle frame, having first and second legs with distal ends for holding a cycle wheel therebetween, the distal ends of the fork legs including or comprising releasable retaining means for retaining the outer raceways of rolling bearings of a cycle wheel for mounting the cycle wheel thereto, as herein described.

According to a fifth aspect of the present invention there is provided adapter means attachable to the legs of a cycle fork to adapt the latter to comprise a cycle wheel mounting as herein disclosed.

According to a sixth aspect of the present invention there is provided a cycle including a frame and at least one fork between the legs of which a wheel is to be mounted, which includes cycle wheel mounting constructed in accordance with the present invention.

According to a seventh aspect of the present invention there is provided a kit of parts comprising components of a cycle wheel mounting or mounting for a cycle wheel, as herein described.

By mounting the wheel hub to the inner raceways and releasably attaching the outer raceways to the legs of a fork, there is no requirement for any axle or other elongate member to support the inner raceways of the bearings and/or secure the wheel hub to the fork.

As employed herein, the term cycle may be a bicycle, a tricycle, a motorcycle or any other type of cycle, and the term fork is intended to mean not only the steerable front fork of a cycle, but also the fixed rear fork of a cycle frame between the legs of which the rear wheel is located.

### BRIEF DESCRIPTION OF THE DRAWINGS

FIG. 1 is a cross-section through the distal end of cycle fork legs;

FIG. 2 is a cross-section through a cycle wheel, when the wheel is not attached to the fork legs;

FIG. 3 is an end of view of the apparatus of FIG. 1, with the cycle wheel mounted on the fork ends;

FIG. 4 shows the apparatus of FIG. 1, with the cycle wheel mounted on the fork ends, in cross-section;

FIG. 5 is a corresponding representation of a rear cycle wheel in end view and cross-section;

FIG. 6 is a cross-section through a rear wheel support with wheel quick release mechanism;

FIG. 7 is an exploded view of components of cycle fork legs;

FIG. 8 is an exploded view of a cycle wheel hub mechanism;

FIG. 9 is a perspective view of cycle fork legs, with wheel hub attached thereto;

FIG. 10 is an exploded perspective view of cycle fork legs and a cycle wheel hub including unitary rolling bearings;

FIG. 11 is a cross-section through the apparatus of FIG. 10 when assembled;

FIG. 12 is a cross-section through the apparatus of FIGS. 10 and 11, adapted for use as a rear wheel of a bicycle; and

FIG. 13 illustrates the apparatus of FIGS. 10 through 12 assembled, in perspective view.

### DETAILED DESCRIPTION OF ILLUSTRATED EMBODIMENTS

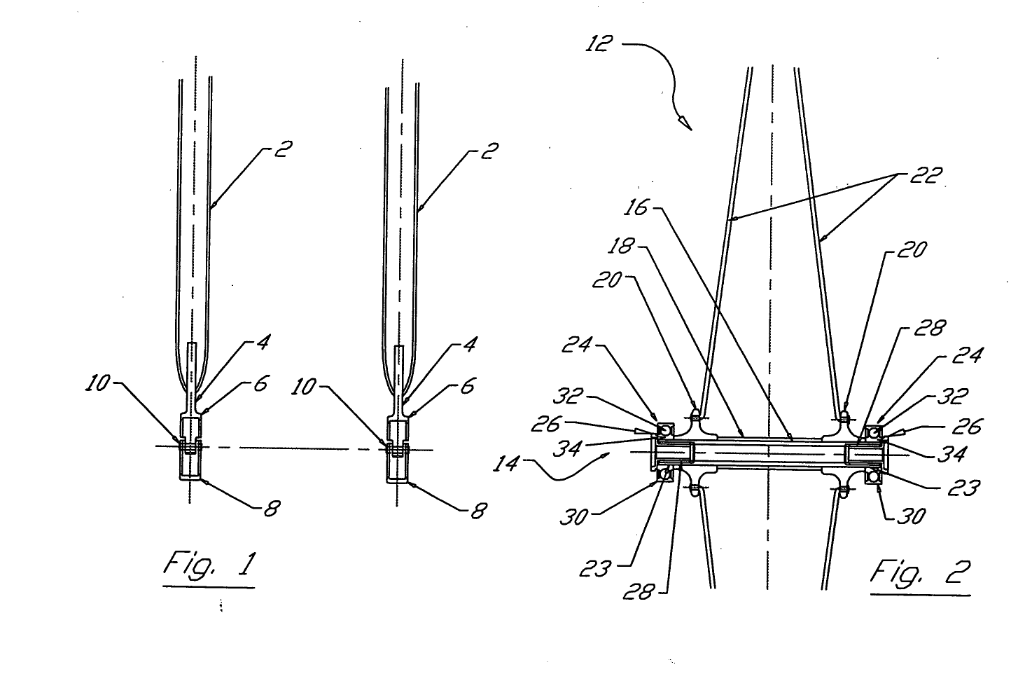

FIG. 1 illustrates in cross section the distal ends of cycle fork legs 2. At the distal end of each fork leg 2 are provided means for attaching the outer raceway of a rolling bearing, in the form of a clamp 4 including upper and lower bearing housings 6, 8, detachably joinable by clamp mechanism 10.

FIG. 2 is a cross section through a cycle wheel shown generally as 12. Wheel 12 includes a hub shown generally as 14. Hub 14 includes includes hollow hub spindle 16, having spacer 18 therearound.

At either end of the spacer 18 and carried on the hub spindle 16 are affixed spoke flanges generally designated 20. Spokes 22 are fitted to the flanges 20 in the conventional manner.

The hub spindle 16 extends beyond the flanges 20 to form wheel bearing supports 23 on which are demountably mounted roller bearings 24. The bearings are each retained in place by means of bolt 26 which is screwed into an internal thread 28 in the hollow ends of the spindle 16.

Each roller bearing 24 comprises an outer raceway 30, which rotates freely around ball bearings 32, and an inner raceway 34, which latter is fixed to one of the extensions 23 of the hub spindle 16 which forms a wheel bearing support.

To affix wheel 12 to the fork legs 2, each roller bearing is engaged between upper and lower bearing housings 6, 8 and fixed in place with quick release clamp 10.

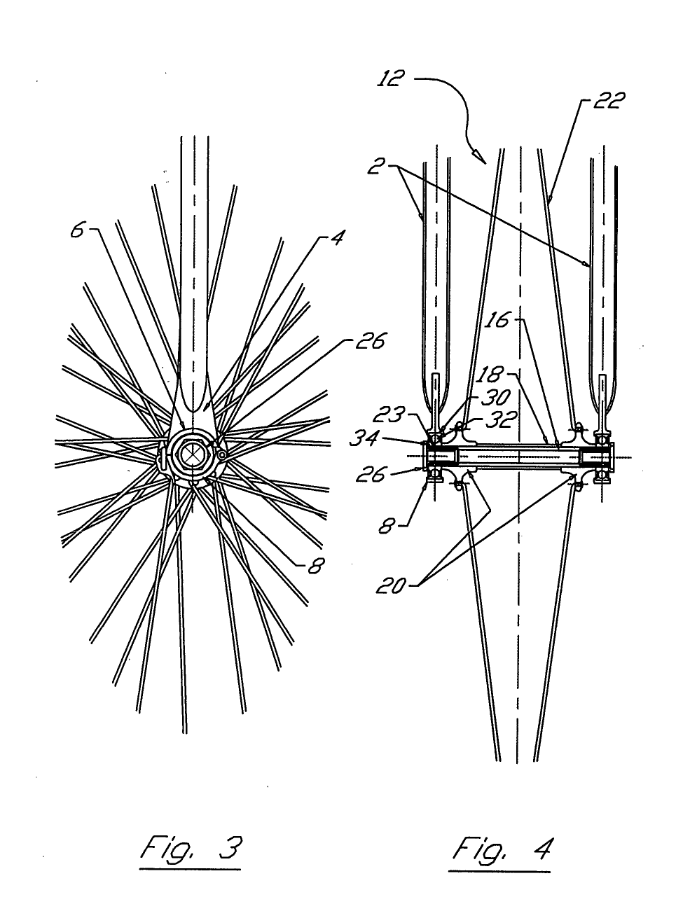

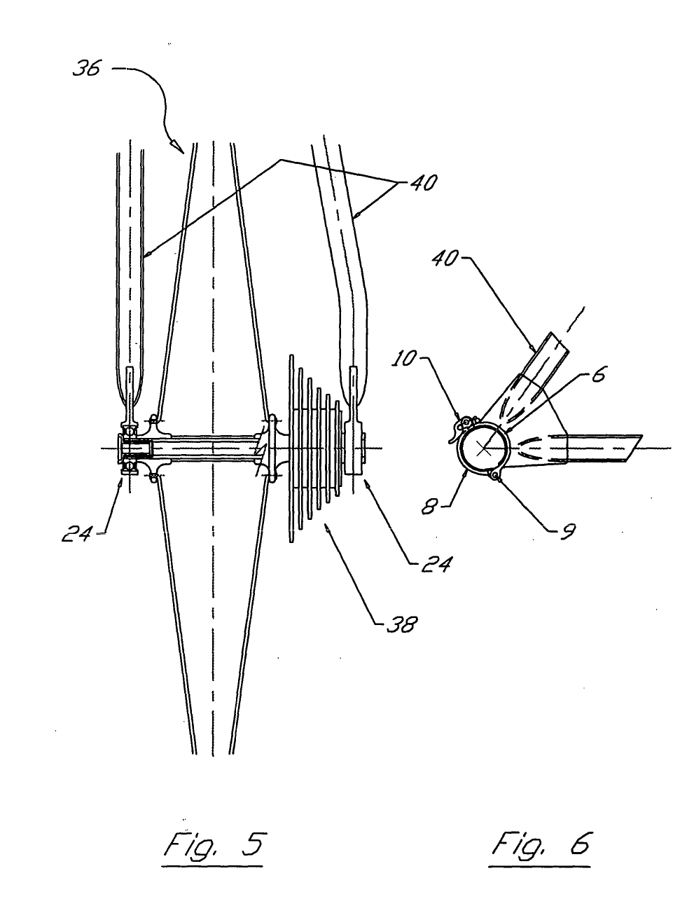

FIG. 3 illustrates the resultant clamped cycle wheel in end view. FIG. 4 is a cross section through the clamped wheel. FIG. 5 is a side view and part cross section of a rear cycle wheel 36 including gear wheels 38 clamped within rear fork legs 40. It will be seen that each roller bearing 24 is in line with the fork legs, thus forces are predominantly orthogonal to the axis of the roller bearing.

FIG. 6 is an end view of supporting rear fork 40 including upper and lower bearing housings 6, 8 and quick release clamp 10. The lower bearing support 8 rotates around pivot 9.

FIG. 7 is an exploded view of components of the means for attaching the outer raceway. Cycle fork leg 2 includes clamp 4 comprising upper bearing housing 6 and lower bearing housing 8. The lower bearing housing 8 is joined to the upper bearing housing 6 by pivot 9. The clamp 10 includes a pivot 11 and a strap 13 operable to engage with upper bearing housing 6.

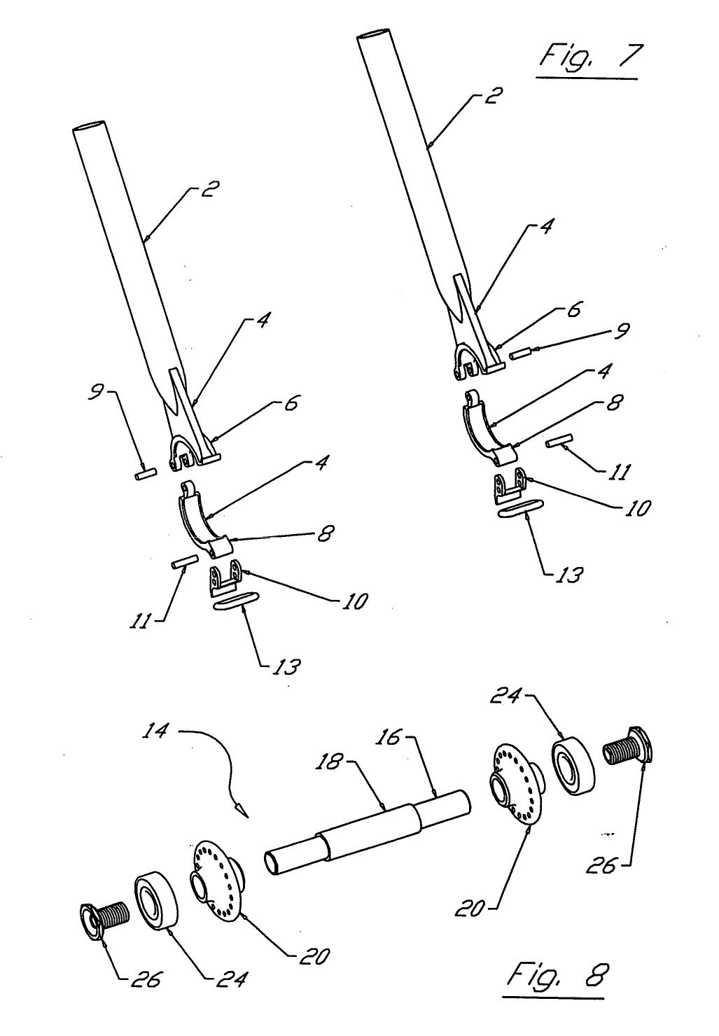

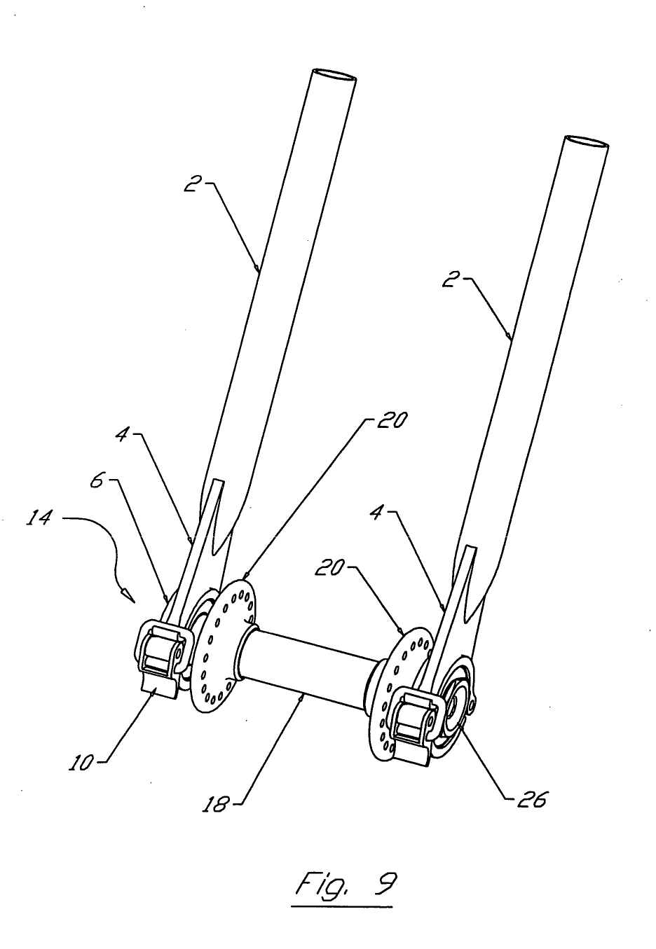

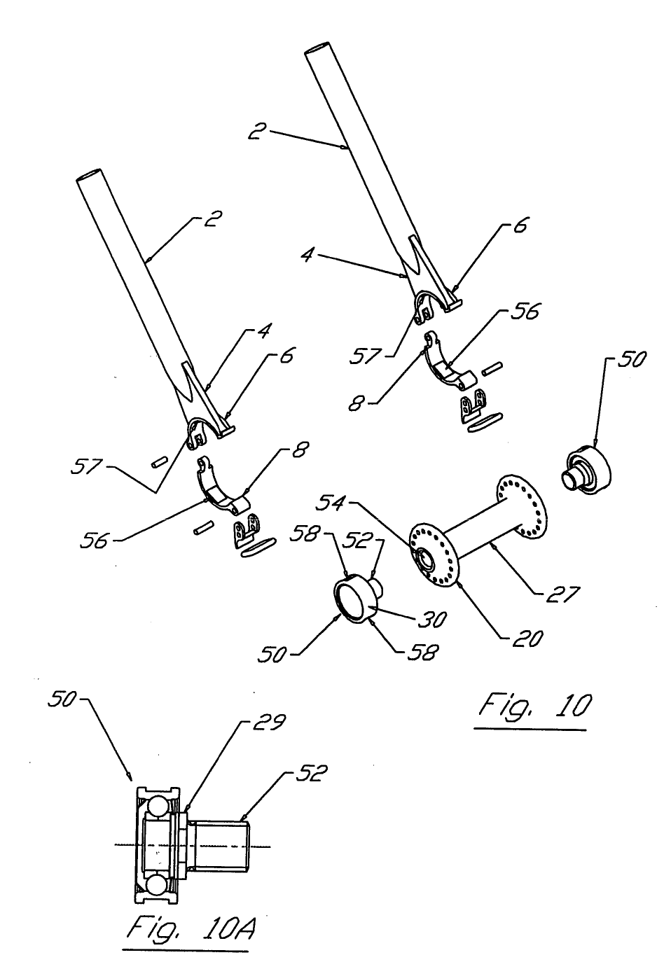

FIG. 8 is an exploded view of cycle wheel hub 14, including hub spindle 16 with sleeve 18 therearound. Spoke flange/bearing abutment 20 fits thereon at either end of the hub 16. Roller bearings 24 are held in place by threaded screws 26.

As the roller bearings 24 are unitary devices, they do not fall apart when the wheel is demounted. They can be individually and easily replaced, simply by loosening threaded screw 26, removing the old rolling bearing 24, and fitting a new roller bearing. The roller bearing can be separately replaced, without needing to remove components of both bearings.

As shown in FIG. 8, the wheel hub has few components, allowing easy manufacture and simple use and repair.

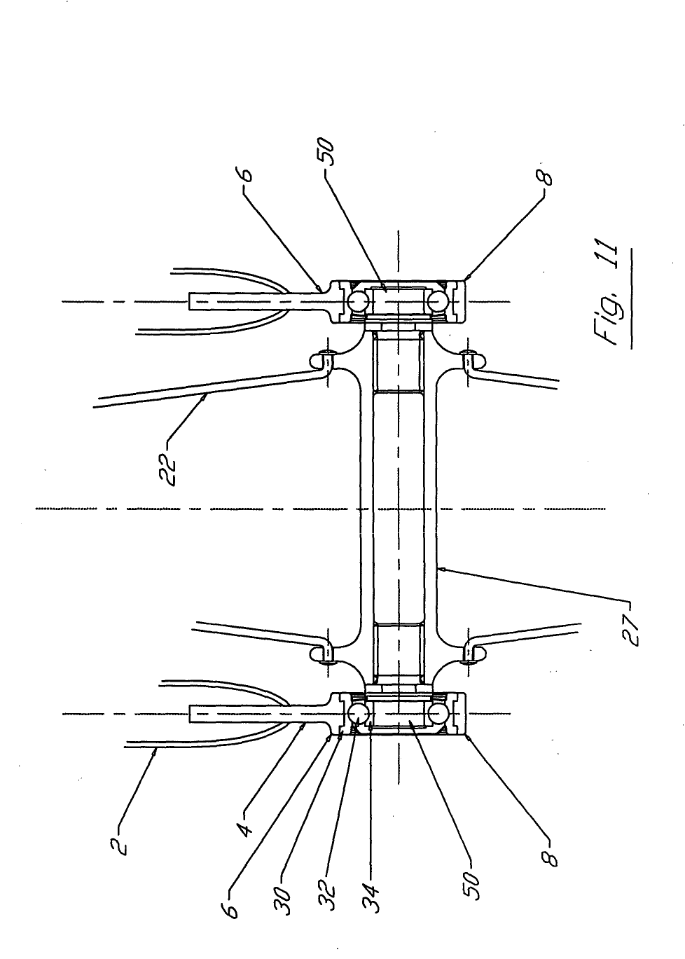

FIG. 9 is a perspective view of the assembled cycle fork ends 2 and hub assembly 14.

In an alternative design, shown in FIG. 10, components 16,18 and 20 which make up the hub are shown manufactured as a unitarydevice, designated 27.

FIG. 10 is an exploded view of a cycle wheel mounting including an alternative enclosed rolling bearing 50, in which the inner raceway extends axially to form a threaded stub 52 1which is screwed into an internal thread 54 at each end of the bottom central core of the unitary hub 27. An external hexagonal profile (see FIGS. 10, 10a) allows stub 52 to be screwed into 54. Cooperating features 56 (on the lower bearing housing 8 and 57 on the upper bearing house 6), and 58 (on the outer raceway 30) of bearing 50 prevent the outer raceway 30 from shifting laterally relative to fork leg 2. Bearing 50 may comprise a dust-cover sealed bearing, of the type used with hay rakes. For example, the 8212-1TN radial ball bearing or CONV 374-TN conveyor bearing, available from Nice Speciality Bearings of Kulpsville, Pa., USA. These bearings include milled slots connected to the outer raceway which may cooperate with both upper and lower bearing housings.

A suitable lubricant for use between the inner and outer raceway of a rolling bearing would be W64, a mixture of lubricating oil and polymers, thermally cured to a rigid, sponge-like gel, available from SKF Group.

The cycle hub of FIG. 10 includes only three components, a simple unitary hub assembly with integral spoke flanges 27 and two demountable rolling bearing 50. It is therefore simple to manufacture and maintain.

FIG. 10A shows one of the bearings 50 partly in cross section and reveals the hexagonal external feature 29 by which it can be tightened into the threaded end 54 of the hollow hub spindle 27.

FIG. 11 is an expanded cross section through the assembled cycle wheel mounting using the components shown in FIG. 10.

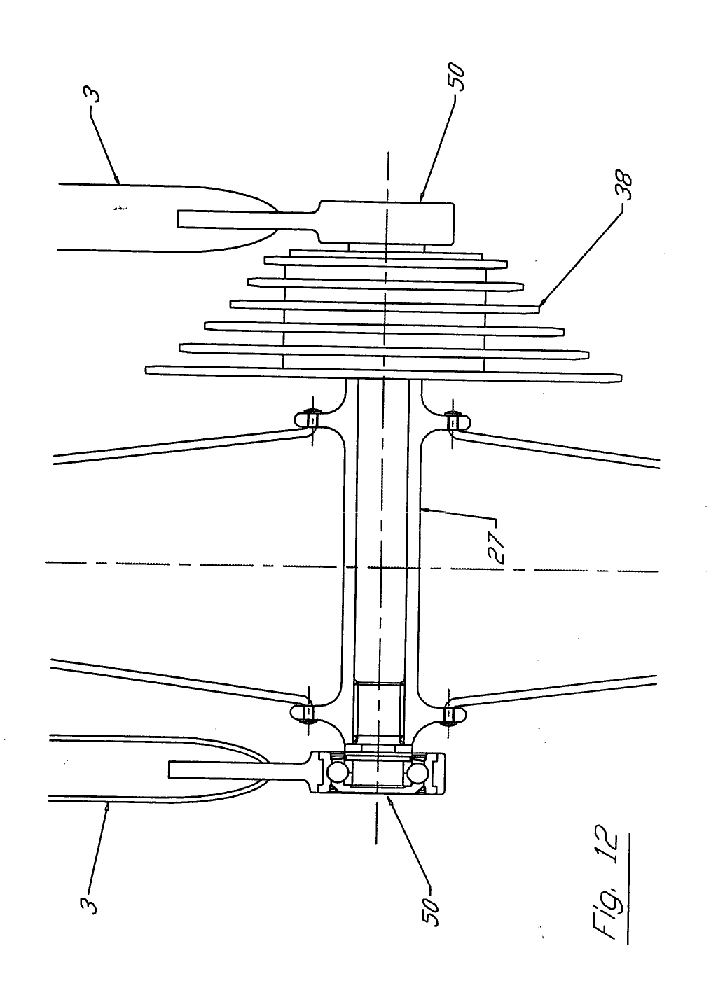

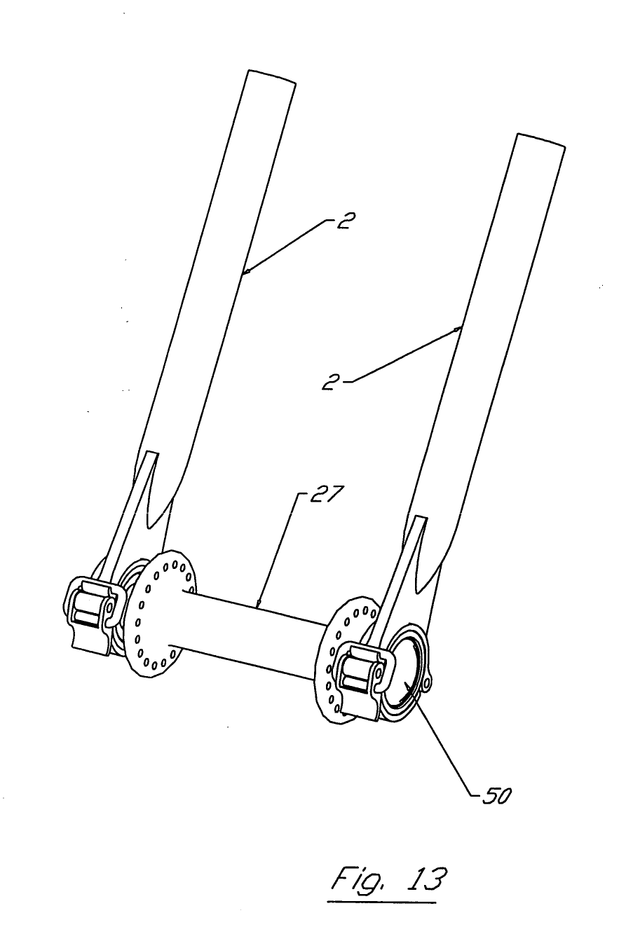

FIG. 12 is an elevation, partly in cross section, through a rear wheel including gears 38, also mounted using bearings such as 50 gripped between upper and lower housings (such as 8, 9 in FIG. 10) at the lower ends of a pair of legs 3 of a rear fork of a bicycle frame.

FIG. 13 is a perspective view of the cycle wheel mounting of FIGS. 10 and 11 including the unitary hub assembly 27 and alternative rolling bearings 50 shown assembled to a pair of front fork legs 2.

1. A mounting for a cycle wheel between the legs of a fork of a cycle frame in which the wheel has rolling bearings comprising inner and outer raceways at opposite ends of a hub, the outer raceways being de-mountably securable to the two legs of the fork, and wherein the inner raceways are removably secured to the hub and will normally remain attached to the hub if the wheel is de-mounted from the fork.

2. A cycle wheel mounting comprising a cycle fork and cycle wheel, the fork having first and second legs with distal ends for holding the cycle wheel therebetween, the cycle wheel including a hub having first and second wheel supports projecting axially outward from the ends thereof, each wheel support having means for attaching thereto an inner raceway which together with an outer raceway forms a rolling bearing, the distal ends of the fork bearing, such that the wheel and rolling bearings can be secured to the fork, and can be removed as a single unit therefrom when required.

3. A cycle wheel mounting as claimed in claim 1 wherein the releasable retaining means comprises an openable annular clamp.

4. A cycle wheel mounting as claimed in claim 2 wherein the releasable mounting includes a quick release catch.

5. A cycle wheel mounting as claimed in claim 4 wherein the catch is configured to retain the outer raceways.

6. A cycle wheel mounting as claimed in any of claims 2 to 5 wherein the retaining means for retaining the outer raceways operate independently, such that each may be engaged and disengaged separately.

7. A mounting as claimed in any of claims 1 to 6 wherein each rolling bearing is a unitary component.

8. A mounting as claimed in any of claims 1 to 7 wherein the components of the rolling bearing ordinarily remain attached to the cycle wheel.

9. A mounting as claimed in any of claims 1 to 8 wherein each rolling bearing is located in line with the fork leg to which it is attached, whereby the external load on the rolling bearings is perpendicular to the central axis of the rolling bearing, thereby reducing mechanical stress on the rolling bearing.

10. A mounting as claimed in any of claims 1 to 9 wherein means for attaching each inner raceway to a wheel support allows the raceway to be de-mounted from its support.

11. A mounting as claimed in claim 10 wherein the means for attaching an inner raceway comprises a threaded screw passing through the inner raceway and threadably engaged to an internally threaded recess within the wheel support, so that in use it holds the raceway against the wheel support.

12. A mounting as claimed in claim 10 wherein the inner raceway of each rolling bearing includes a screw-threaded stub axially protruding from one end thereof and is retainable in use by being screwed into an internally threaded recess in the wheel support.

13. A mounting as claimed in any of claims 1 to 12 wherein the rolling bearings remain attached to the cycle wheel hub when the wheel is demounted from the fork, but after a wheel is so demounted they can be removed from the hub for replacement.

14. A mounting as claimed in any of claims 1 to 13 wherein the means for attaching the inner raceways of the bearings to a hub are independent of each other, allowing each rolling bearing to be independently de-mounted.

15. A mounting as claimed in any of claims 1 to 14 wherein each rolling bearing is a sealed bearing.

16. A mounting as claimed in any of claims 1 to 15 wherein the inner raceway is an integral part of the hub.

17. A hub for a cycle wheel for use in a mounting as claimed in any of claims 1 to 8 formed as a single unitary structure.

18. A hub as claimed in claim 17 having a flange at each end, with the first and second wheel supports projecting outwardly from the flanges.

19. A hub as claimed in claim 18 in which the flanges form part of the same unitary structure as the rest of the hub.

20. A hub as claimed in claim 18 or 19 when forming part of a cycle wheel which includes spokes and the latter extend from the flanges to the rim of the wheel.

21. A cycle wheel including a hub as claimed in any of claims 17 to 20.

22. A cycle fork forming part of a cycle frame or adapted to be attached to a cycle frame, having first and second legs with distal ends for holding a cycle wheel therebetween, the distal ends of the fork legs including or comprising releasable retaining means adapted to retain the outer raceways of rolling bearings of a cycle wheel, whereby the cycle wheel can be mounted thereto.

23. Adapter means attachable to the legs of a cycle fork to adapt the latter to comprise a cycle wheel mounting as claimed in any of claims 1 to 16.

24. A cycle including a frame and at least one fork between the legs of which a wheel is to be mounted, which includes cycle wheel mounting as claimed in any of claims 1 to 16.

25. A kit of parts comprising components of a cycle wheel mounting or a mounting for a cycle wheel as claimed in any of claims 1 to 16.
